(19) United States
(12) Patent Application Publication
(10) Pub. No.: US 2006/0207438 A1
(43) Pub. Date: Sep. 21, 2006

(54) Method and device for deep-frying food

(76) Inventor: Neil Anthony Currie, Worcestershire (GB)

Correspondence Address: BACON & THOMAS, PLLC, 625 SLATERS LANE, FOURTH FLOOR, ALEXANDRIA, VA, 22314, US

(21) Appl. No.: 10/544,384

(22) PCT Filed: Feb. 4, 2004
(86) PCT No.: PCT/EP04/01035

§ 371 Date: May 16, 2006

(30) Foreign Application Priority Data
Feb. 1, 2003 (DE) 10304472.8

(51) Int. Cl. A47J 37/12

(52) U.S. Cl. 99/403

(57) ABSTRACT

The invention relates to a deep-frying device having a closed system, wherein the frying fat or oil can be pumped round continuously from a feedstock reservoir (3), in which the oil can be kept at the desired temperature, to the deep-frying vessel (2) and back to the feedstock reservoir (3), cleaning of the oil being carried out, during the return of the latter from the deep-frying vessel (2) to the feedstock reservoir (3), by feeding the oil into an overflow centrifuge (9), the centre line of which forms an angle with the vertical and in which is located a disposable bag (12′) in which contaminants are collected, which bag (12′) can be removed via a front aperture by taking out the bag as soon as a regulating system has ensured that the deep-frying vessel (2) has been emptied via the centrifuge (9), and wherein the heating preferably takes place indirectly by means of a hot medium, such as a fluid, which circulates through double walls (23, 24; 25, 26) of the feedstock reservoir (3′) and the deep-frying vessel (2′).

The invention relates to a method and a device for deep-frying foods, wherein oil deep-frying or deep-frying fat is heated in a deep fat fryer, and the food is deep-fried in the hot deep-frying oil or deep-frying fat.

Such deep fat fryers are known. Here, the deep fat fryer receives a deep-frying medium, for example deep-frying oil or deep-frying fat, which is first melted, if required, by a heating device and is thereafter heated to a temperature of, for example, 100 to 200° C., in particular 150 to 190° C. Various foods, here called deep-fried items, such as meat, fish, onion rings, mushrooms, vegetables, French fries or the like, can be deep-fried within a few minutes. In the instant context, the term “deep-frying” includes every type of food preparation in hot fat or oil, such as for example, roasting, baking or cooking. As a rule, a basket receiving the deep-fried items, which can be made of a woven wires, for example, is used for deep-frying. The basket assures that the deep-fried items can be introduced into the hot oil or fat safely and without problems, and can be removed again at the end of the deep-frying process. Excess fat or oil can drip off through the woven wire.

If in what follows primarily deep-frying oil or deep-frying fat is mentioned, this is not intended merely to identify fat which is solid or liquid at room temperature, but also fat having a pasty or gel-like consistency at room temperature.

Many deep fat fryers have a heating device which is fixedly connected with the deep-frying vessel. Often the heating device is arranged underneath the bottom of the deep-frying vessel, so that first the deep-frying vessel is heated, and thereafter the fat or oil contained in the deep-frying vessel. Deep-frying vessels have also become known, where the heating device is arranged in the interior of the deep-frying vessel. Advantages of this type of vessel are considered to be that the heating device is in direct contact with the deep-frying oil or fat, so that a more rapid heating of the deep fat frying medium is assured. Typically, the heating device is embodied as a heating coil, so that smaller remaining particles of the material to be deep-fried can sink past the heating element to the bottom of the deep-frying vessel. Then such particles or food residues are no longer located in the immediately vicinity of the heating element, instead they are in the cooler bottom area of the deep-frying vessel. In the course of a subsequent deep fat frying process, such residues burn or decompose to a clearly reduced extent than is the case with deep-frying vessels with heated bottoms. It is then possible to use the deep-frying oil or fat for longer periods of time, because it is less intensely burdened by decomposition products of food residue.

However, with all known deep fat fryers it is necessary sooner or later to replace the used-up deep-frying oil or deep-frying fat with fresh deep-frying medium.

In this case, the user customarily must wait until the oil in the deep-frying vessel has cooled to a large extent, so that the danger of scalding is avoided. In connection with commonly employed deep fat fryers without an outlet opening for the oil, the entire deep fat fryer must be lifted up and the oil poured over the upper opening of the deep-frying vessel into a collection container. Not only is this quite cumbersome because of the weight and dimension of the deep fat fryer, but is also connected with considerable danger of injury by the hot oil, in particular in those cases in which the deep-frying medium has not been completely cooled.

However, deep fat fryers have already become known, which contain a closable opening for removing the deep-frying oil. Such closable opening can be operated by the user by means of a ball valve. However, if not properly operated, there is the danger of the user coming into contact with possibly still hot deep-frying oil and sustaining considerable scalding. A deep fat fryer, which at present is commercially available, is described in U.S. Pat. No. 6,085,641, which contains an opening for removing the deep-frying oil which is extended by a flexible hose. In the course of correct usage of the deep fat fryer, the hose is kinked at the front face of the deep fat fryer by means of a pivotable plate, so that the opening is closed. For letting the deep-frying oil off, the plate is flipped open, so that the hose can be guided into a reception vessel. With this known deep fat fryer there is also the danger of the deep-frying oil running off uncontrolled, which at least leads to undesirable soiling of the kitchen and, in case of an accidental release of hot deep-frying oil, again presents the danger of scalding.

It is moreover known that many users do not properly dispose of the oil, but instead simply pour it into a drain, which not only can lead to obstructed drain pipes, but also represents an unnecessary strain on the environment.

Therefore the present invention is based on solving the technical problem by means of providing a method and a device for deep-frying food which assure a simple and dependable removal of used deep-frying oil or deep-frying fat.

This technical problem is solved here by employing a heat-resistant one-way container for deep-frying oil or deep-frying fat for deep-frying food in a deep fat fryer. In accordance with the invention, the deep-frying oil or deep-frying fat is not directly introduced into the deep-frying vessel as with conventional deep fat fryers and heated there, but is arranged in a heat-resistant one-way container in the deep fat fryer. As soon as the oil or fat is used up and must be replaced by fresh deep-frying medium, the user merely needs to remove the one-way container with the used-up deep-frying medium from the deep-frying vessel and to replace it with a new one-way container with fresh oil or fat. The one-way container with the used-up oil can be disposed of correctly in an environmentally friendly manner in a recycling center or a yard for recovering valuable materials.

The deep fat fryer is easy to clean, since no, or only slight soiling of the deep-frying vessel itself occurs.

Accordingly, a method for deep-frying foods is also an object of the invention, wherein deep-frying oil or deep-frying fat is heated in a deep-frying vessel of a deep fat fryer and the food is deep-fried in the hot deep-frying oil or deep-frying fat, wherein the method in accordance with the invention is distinguished in that the deep-frying oil or deep-frying fat is heated in a one-way container which can be removed from the deep-frying vessel.

The one-way container can be matched to the shape of the deep-frying vessel of already existing deep fat fryers, so that conventional deep fat fryers can also be retrofitted within the meaning of the invention. New deep fat fryers, which are specially designed for the use of a one-way container, can be equipped with deep-frying vessels made of more cost-effective materials, since the vessels no longer need to withstand abrasive cleaning. In place of deep-frying vessels made of special steel, enameled steel or aluminum with anti-adhesive coatings, it is possible to employ simple thin-walled steel vessels with a less complicated protective coating, or uncoated aluminum vessels.

The one-way container can be designed as a separate consumable article, which is arranged in the deep-frying vessel and is filled with fresh deep-frying oil, for example from a bottle or a canister.

However, the one-way container preferably is simultaneously used as a packaging or transport container for the fresh deep-frying oil or deep-frying fat. In this way the packaging waste being created is drastically reduced, because the packaging is not only used as the interior vessel for heating the oil, but also as a waste bag, so to speak, for used-up deep-frying oil or deep-frying fat.

Preferably the shape of the one-way container is matched to the interior shape of the deep-frying vessel. For example, dimensionally stable one-way containers can be inserted simply into the deep-frying vessel. However, in an advantageous manner the one-way container will be fixed in place in the deep-frying vessel prior to its use. In accordance with a preferred embodiment of the method in accordance with the invention, to this end the one-way container is releasably fastened on the rim of the deep-frying vessel. For this, the upper edge of the one-way container can for example be bent around the rim of the deep-frying vessel. Alternatively or in addition, the upper edge of the one-way container can be fixed in place on the rim of the deep-frying vessel by means of suitable clamping devices, for example one or several clips, or a circumferential clamping ring.

As already mentioned above, a particular advantage of the method in accordance with the invention consists in that it is possible to dispose of used deep-frying oil or deep-frying fat in the one-way container.

If the one-way container is used as packaging and/or transport container for the deep-frying oil or deep-frying fat, it is preferably closed off by means of a protective foil, which can be pulled off, a lid, which can be flipped open, or some other removable cover. This cover is of course removed prior to first use. The one-way container preferably can be closed again for disposing the used deep-frying oil or deep-frying fat. To this end, the walls of the container can be folded together, for example, or can be closed by means of a groove-and-tongue arrangement. Alternatively, the opening of the one-way container can also be closed by means of a drawstring.

The closable, or also the non-closable one-way container can also be disposed of in a separate closable disposal bag.

A deep fat fryer furthermore is an object of the invention, having at least one deep-frying vessel provided for receiving deep-frying oil or deep-frying fat and a heating device for heating the deep-frying oil, which is distinguished in that the deep-frying oil or deep-frying fat are arranged in the deep-frying vessel in a removable one-way container.

Means for fastening the one-way container at the rim of the deep-frying vessel are advantageously provided.

In a particularly preferred manner, the means for fastening the one-way container are constituted by a circumferential edge of the one-way container.

The means for fastening the one-way container alternatively or additionally comprise a clamping device, such as one or several holder clips, or a clamping ring, for example.

The heating device preferably has a heating element which can be inserted into the one-way container and is provided on its underside with a plate for leveling the underside of the one-way container, so that a flexible one-way container, for example, optimally matches the bottom of the deep-frying vessel. The plate itself is preferably perforated, so that the deep-frying oil can circulate through the plate. Advantageously the plate is simultaneously used as a reflector of the infrared radiation emitted by the heating element, so that optimal heating of the deep-frying oil is assured. However, a heating device integrated into the deep-frying vessel can also be provided. In this case a good thermal contact between the deep-frying vessel and the one-way container should be provided. It is alternatively possible to heat one-way containers made of a suitable material, or one-way containers having inserts of suitable materials, by means of an inductive heating device.

Finally, the invention relates to a one-way container for deep-frying oil or deep-frying fat, which can be employed in connection with the method of the invention or the deep fat fryer of the invention, wherein the one-way container is made of a heat-resistant material, for example heat-resistant plastic, such as polyester, a thin metal foil, for example an aluminum foil, or a laminated structure made of plastic and metal layers. Here, the container material should withstand at least temperatures of 250° C. and more. The preferred strength or thickness of the metal foil here is 0.01 mm to 0.5 mm, particularly preferred 0.05 mm to 0.3 mm, and particularly preferred approximately 0.1 mm.

Particularly advantageously, the body of the one-way container is designed as a seamless one-piece component, so that the danger of the appearance of leaks is reduced. For example, such a container can be produced by means of deep-drawing. In accordance with an advantageous embodiment, the container can also be folded from a single flat cut-to-size element and put together by means of gluing or welding spots.

A set is also the object of the invention, which comprises a one-way container in accordance with the invention, a container with fresh deep-frying oil, for example a bottle or bag, as well as a disposal bag.

The invention will be described in greater detail in what follows by means of exemplary embodiments represented in the attached drawings. Elements of different embodiments, which perform the same or corresponding functions, will be identified by the same reference numerals in the drawing figures.

Shown in the drawings are in:

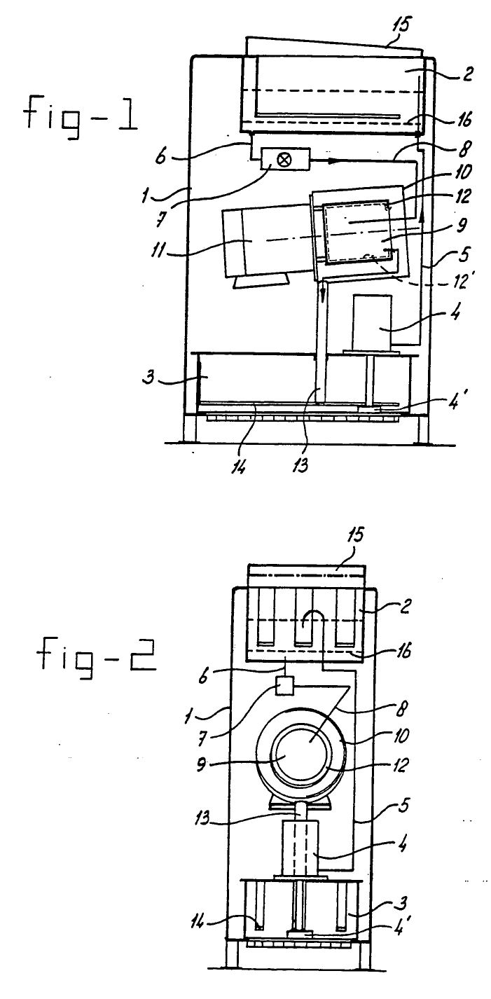

FIG. 1, a deep fat fryer with a first variation of the one-way container in accordance with the invention for deep-frying oil or deep-frying fat,

FIG. 2, a first variation of a fastening of the one-way container in the deep fat fryer,

FIG. 3, the one-way bag in the variation of FIG. 2, removed from the deep fat fryer,

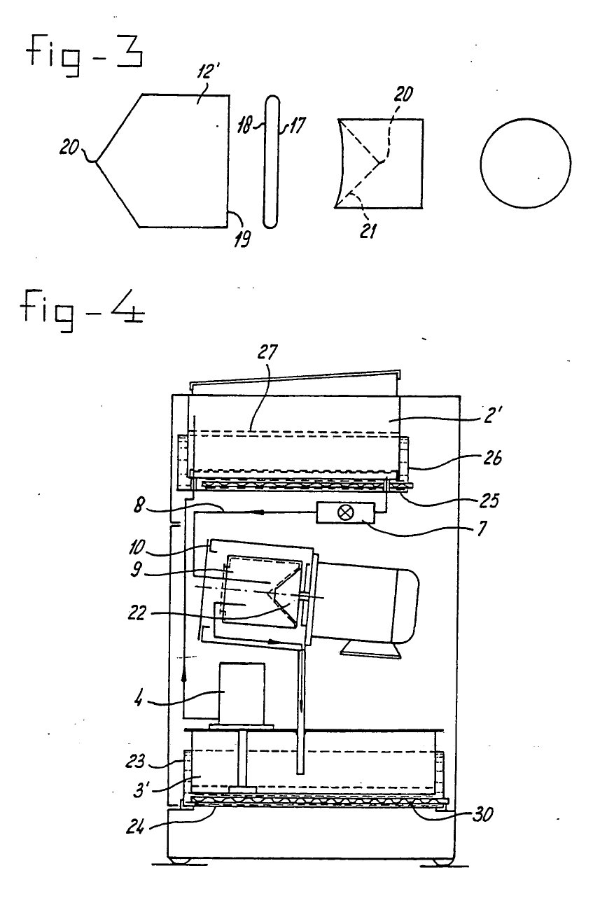

FIG. 4, a second variation of a fastening of the one-way container in the deep fat fryer,

FIG. 5, the one-way bag in the variation of FIG. 4, removed from the deep fat fryer,

FIG. 6, a third variation of a fastening of the one-way container in the deep fat fryer,

FIG. 7, an additional disposal bag for the one-way container in accordance with the invention,

FIG. 8, a variation of the disposal bag in FIG. 7,

FIG. 9, a cross section of a deep fat fryer with a one-way container and a heating element inserted therein,

FIG. 10, a detailed portion of the cross-sectional representation in FIG. 9,

FIG. 11, a further cross section of a deep fat fryer with a variation of the one-way container of the invention,

FIG. 12, a variation of the use of the one-way container of the invention,

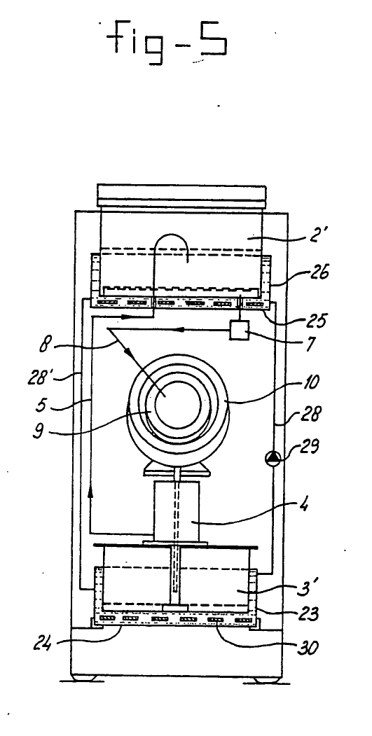

FIG. 13, a cross section of a deep fat fryer with a bottom heating device corresponding to the cross section in FIG. 9,

FIG. 14, a commercial model of the one-way container of the invention with an oil container and disposal bag,

FIG. 15, a cut-to-size element for producing a folded one-way container,

FIG. 16, a first intermediate step in folding the cut-to-size element in FIG. 15,

FIG. 17, a second intermediate step,

FIG. 18, the one-way container folded from the cut-to-size element in FIG. 15, and

FIG. 19, the folded-up one-way container of FIG. 18.

A deep far fryer 10 is reproduced in FIG. 1 in an exploded view. The deep fat fryer 10 consists of a deep-frying vessel 11, which is surrounded by a housing shell 12. Deep-frying oil or deep-frying fat is introduced in the customary manner into the deep-frying vessel 11 and is heated by means of a heating device 13 inserted into the deep-frying vessel 11. The heating device 13 has a heating element 14, as well as a control device 15 for regulating the heating output. The insulating housing shell 12 prevents the user from coming into direct contact with the hot deep-frying vessel. In accordance with the invention, the deep-frying oil or deep-frying fat is not directly introduced into the deep-frying vessel 11, but is placed into the deep-frying vessel 11 in a one-way container 16, which is simultaneously used as its packaging. Prior to first use, the fresh deep-frying oil or deep-frying fat is protected against soiling by a protective foil 17, which can be pulled off. As already indicated in FIG. 1, the protective foil 17 must be pulled off before the heating device 13 can be inserted. The container 16 has tongues or handles 18 on the sides for easier insertion into and removal from the deep-frying vessel 11 of the one-way container 16 which, with the one-way container introduced, project above the upper rim of the deep-frying vessel. After pulling off the protective foil 17 and the insertion of the heating device 13, the deep fat fryer is ready for operation and the oil or fat can be heated. Following the heating of the oil, the food to be deep-fried is introduced into the oil in a deep-frying basket (not represented here), the same as in conventional deep fat fryers. The important difference from conventional deep fat fryers consists in that with the deep fat fryer in accordance with the invention the hot oil remains in the one-way container 16. If the oil is used up after several operations, i.e. in particular if it contains an increasing amount of decomposition products of food remnants, the one-way container 16 is removed from the deep-frying vessel 11, and the oil in the one-way container 16 can be disposed of.

A variation of the one-way container 16 in FIG. 1 is represented in FIG. 2 and it is again identified by the reference numeral 16 for easier association. The one-way container 16 has been inserted into the deep-frying vessel 11, wherein it is not important for the present invention whether, as in FIG. 1, the deep-frying vessel 11 is surrounded by a further housing (reference numeral 12 in FIG. 1) or, as in the representations in FIG. 2 and those following, is embodied as a separate deep-frying vessel 11. The upper edge 19 of the one-way container 16 is bent over the rim 20 of the deep-frying vessel for fastening the one-way container 16 in the deep-frying vessel 11. Thin metal strips 21 have been inserted into the upper edge 19, which permits the closing of the one-way container 16 by folding the upper edge 19 over when the used-up oil or fat is to be disposed of, as represented in FIG. 3.

FIGS. 4 and 5 show a variation of the one-way container 16 corresponding to FIGS. 2 and 3, wherein a drawstring 22 has been inserted into the upper edge 19 of the container 16, which makes it possible to close the opening 23 of the container 16.

A variation of the fastening of the one-way container 16 in the deep-frying vessel 11 is represented in FIG. 6, wherein the upper edge 19 of the one-way container is fastened at the upper rim 20 of the deep-frying vessel 16 with the aid of a clamping ring 24. It is alternatively also possible to distribute one or several holder clips over the circumference of the deep-frying vessel 11.

In accordance with a preferred variation of the invention, the one-way container 16 is disposed of in a separate disposal bag, such as represented by way of example in FIG. 7. The use of a separate disposal bag 25, into which the one-way container 16 can be introduced, is in particular preferred if the one-way container 16 cannot be closed again. The disposal container 25 can be closed by any means, for example by a groove-and-tongue arrangement 27, 28 provided at the upper edge 26 of the bag, which is brought together by a movable slider 29 and is closed in that way. Such closure systems are widely used in connection with freezer bags. However, such a closure system can of course also be provided for closing the one-way container 16 itself, alternatively to the variations described in FIGS. 2 to 5.

FIG. 8 shows a particularly simple variation of the disposal bag 25, which is sufficiently long so that, following the introduction of the one-way container 16 filled with used-up deep-frying oil, the upper edge 26 can be tied off by a simple knot 29.

Preferably the one-way container 16 is matched to a large extent to the shape of the deep-frying vessel 11. However, if the one-way container 16 is made of a relatively flexible material, for example of a thin aluminum foil, when using it in a deep-frying vessel with an immersion heating element it can be advantageous if, as represented in FIG. 9, a perforated plate 30 is arranged underneath the heating element 14 of the heating device 13, which assures that the underside 31 of the one-way container 16 rests as levelly as possible on the bottom 32 of the deep-frying vessel. In this variation the one-way container is not held on the rim of the deep-frying vessel, but instead is supported on its bottom 32.

As shown in the detailed representation in FIG. 10, the edges 33 of the plate 30 are preferably rounded, so that the thin wall of the one-way container 16 is not damaged. The openings 34 of the perforated plate 30 make possible the circulation of the heated fat and make the insertion of the heating element into the deep-frying oil possible. The plate 30 moreover is used as a reflector of the heat radiation emitted by the heating element 14, so that it is possible to achieve a more effective heating of the oil.

FIG. 11 shows a variation of the embodiment in FIGS. 9 and 10. In this variation, the bottom 32 of the deep-frying vessel 11 has ventilation openings 34′, so that cool ambient air can flow in by means of convection and can rise along the outer edge of the one-way container 16. Because of this it is possible to always keep the bottom on which the deep-frying vessel 11 stands cool during the operation. Furthermore, the effective cooling air convection reduces the cooling time of the oil, so that the danger of scalding when taking out the one-way container 16 is reduced. In the variation in accordance with FIG. 11 the one-way vessel 16 is not suspended from the rim of the deep-frying vessel 11, but instead rests on its bottom 32 for reasons of stability. In this variation the pressure plate 30 is made shorter than in the embodiment of FIG. 9 and, as can be seen in the drawing, is arranged only under the front portion of the heating element 14. But the plate 33 again has a rounded edge 33 in order to prevent the perforation of the thin metal foil of the one-way container 16. The deep-frying oil 36 can be sold, for example in a form where it is liquid or solid at room temperature, or as a gel, in a closed one-way container 16 or, as indicated by the deep-frying oil containers 37, 37′, it can be introduced by the user into the one-way container 16 from bottles 37 or containers 37′ prior to the first use.

The one-way container 16 in accordance with the invention can be used in deep fat fryers having heating devices which are inserted into the deep-frying vessel, as well as in connection with deep fat fryers in which the heating element 35 is integrated into the bottom 32 of the deep-frying vessel 11. This is schematically represented in FIGS. 12 and 13, wherein in the variation represented in FIG. 12 the one-way container 16 is not used as a packaging container, but instead fresh deep-frying oil 36 is poured from a separate bottle 35 into the one-way container 16, so that the latter is later only needed for disposing of the deep-frying oil. As indicated in FIG. 12, the one-way container 16 can be so flexible that the hydrostatic pressure of the deep-frying oil alone is sufficient to assure good thermal contact between the wall of the one-way container 16 and the heating element 35 of the deep-frying vessel 11. In the variation of FIG. 13, the one-way container is sufficiently rigid and is provided with a flat bottom which, if required, is additionally reinforced, so that here, too, good thermal contact between the heating element 35 and the one-way container 16 is assured. It is of course also possible to additionally provided a heat conductor, for example a heat-conducting paste, between the bottom of the one-way container 16 and the heating element 35.

FIG. 14 shows a typical commercial model of the invention, wherein a one-way container 16 in accordance with the invention, together with a bottle 37 with fresh deep-frying oil and a disposal bag 25, is offered.

A foldable one-way container 16 is represented in FIGS. 15 to 19, which is seamlessly folded from a cut-to-size element 38, so that a container can be produced, which to a large extent is leak-proof. To this end, the cut-to-size element 38 is first folded vertically upward along the lines 39, 40, 41, 42 extending parallel with the longitudinal edges of the cut-to-size element 38, as represented in FIG. 15, while the corners of the cut-to-size element are folded together along the lines 43, 44, 45 and 46, so that the cube with outward projecting corners 47, 48, 49 and 50 represented in FIG. 16 is created. Each half of the corners is folded back along the lines 51, 52, so that the body represented in FIG. 17 results. The tips of two oppositely-located corners 48, 50 are folded downward and glued to the surfaces 53, 54. Thereafter, all four corners are folded over and glued to the exterior body of the cube, so that container 16 represented in FIG. 18 results, in which two tips 55, 56 of the corners 47 and 49 project upward and can be used as handles. Finally, FIG. 19 shows the container 16 in a folded-together state, in which it can be sold as an accessory for deep fat fryers, for example.

1. Use of a heat-resistant one-way container (16) for deep-frying oil or deep-frying fat for deep frying food in a deep fat fryer.

2. A method for deep-frying food, wherein deep-frying oil or deep-frying fat is heated in a deep-frying vessel (11) of a deep fat fryer (10) and the food is deep-fried in the hot deep-frying oil or deep-frying fat,
characterized in that
the deep-frying oil or deep-frying fat is heated in a one-way container (16) which can be taken out of the deep-frying vessel (11).

3. The method in accordance with claim 2, characterized in that fresh deep-frying oil or deep-frying fat is introduced into the one-way container (16) prior to heating.

4. The method in accordance with claim 2, characterized in that fresh deep-frying oil or deep-frying fat is conditioned in the one-way container (16) used as the transport container, and that the one-way container (16) is arranged in the deep-frying vessel (11) prior to heating.

5. The method in accordance with one of claims 2 to 4, characterized in that the one-way container (16) is releasably fastened on the rim (20) of the deep-frying vessel (11).

6. The method in accordance with one of claims 2 to 5, characterized in that used-up deep-frying oil or deep-frying fat is disposed of in the one-way container (16).

7. The method in accordance with claim 6, characterized in that the one-way container (16) can be reclosed.

8. The method in accordance with one of claims 6 or 7, characterized in that the one-way container (16), together with the deep-frying oil or deep-frying fat, is removed from the deep fat fryer and is disposed of in a closable disposal bag (25).

9. A deep fat fryer, having a deep-frying vessel (11) intended for receiving deep-frying oil or deep-frying fat and a heating device (13) for heating the deep-frying oil,
characterized in that
the deep-frying oil or the deep-frying fat is arranged in a removable one-way container (16) in the deep-frying vessel (11).

10. The deep fat fryer in accordance with claim 9, characterized in that means (20, 21, 22, 23) for fastening the one-way container (16) on the rim (20) of the deep-frying vessel are provided.

11. The deep fat fryer in accordance with claim 11, characterized in that the means for fastening the one-way container (16) are constituted by a rim (20, 21) of the one-way container (16), which can be folded over.

12. The deep fat fryer in accordance with one of claims 10 or 11, characterized in that the means for fastening the one-way container (16) comprise a clamping device (24).

13. The deep fat fryer in accordance with one of claims 9 to 12, characterized in that the heating device (13) includes a heating element (14), which can be introduced into the one-way container (16), and that on its underside a plate (30) for leveling the underside (31) of the one-way container (16) is provided.

14. A one-way container for deep-frying oil or deep-frying fat for use in the method in accordance with one of claims 2 to 8, and/or in the deep fat fryer in accordance with one of claims 9 to 13, characterized in that the one-way container (16) is made of a heat-resistant material.

15. The one-way container in accordance with claim 14, characterized in that the body of the one-way container (16) is designed as a seamless one-piece element.

16. The one-way container in accordance with claim 15, characterized in that the one-way container (16) has been seamlessly folded from a single cut-to-size element (38).

17. The one-way container in accordance with one of claims 14 to 16, characterized in that it has been formed from an aluminum foil.

18. The one-way container in accordance with claim 17, characterized in that the aluminum foil has a thickness of 0.01 mm to 0.5 mm, preferably of 0.05 mm to 0.3 mm.

19. A set consisting of a one-way container (16) in accordance with one of claims 14 or 15, of a container (37, 37′) of deep-frying oil, and of a disposal bag (25).
